(19) United States
(12) Patent Application Publication
(10) Pub. No.: US 2015/0256048 A1
(43) Pub. Date: Sep. 10, 2015

(54) OPENING/CLOSING BODY OPERATION DEVICE

(71) Applicant: HI-LEX CORPORATION, Takarazuka-shi, Hyogo (JP)

(72) Inventors: Yuki Ohta, Takarazuka-shi (JP); Masakazu Karaki, Takarazuka-shi (JP); Hitoshi Osafune, Takarazuka-shi (JP)

(21) Appl. No.: 14/431,708

(22) PCT Filed: Sep. 25, 2013
(86) PCT No.: PCT/JP2013/075807

§ 371 Date: Mar. 26, 2015

(30) Foreign Application Priority Data
Sep. 26, 2012 (JP) 2012-212046

(51) Int. Cl. H02K 7/06; H02K 7/14

(52) U.S. Cl. CPC H02K 7/06; H02K 7/14

(57) ABSTRACT

An opening/closing body operation device for operating an opening/closing body, which swings up and down, so as to open and close, has a driving unit, a slider which is moved up and down by the driving force from the driving unit and is linked to the opening/closing body and a guide member having the slider slidably disposed in the interior. The slider includes a main slider body, a sliding member that slides on the guide member, and an elastic member between the main slider body and the sliding member to support the load applied to the slider when the opening/closing body is opened or closed. The slider has a deformation allowance space for allowing elastic deformation of the elastic member caused when the slider is pressed into the guide member. Thus, the load applied to the slider to open or close the opening/closing body is reliably supported.

### TECHNICAL FIELD

The present invention relates to an opening/closing body operation device for opening/closing an opening/closing body configured to swing up and down.

### BACKGROUND ART

In most cases, a vehicle such as a car and etc. is provided with an opening/closing body such as a back door, a trunk door (trunk lid), or etc. that is arranged to an opening at the back and can swing up and down. In addition, a recent vehicle is provided with an opening/closing body operation device configured to open/close the opening/closing body by electric power.

For example, Patent Literature 1 suggests a slider driving device (opening/closing body operation device) using electric power. The slider driving device disclosed in Patent Literature 1 includes a screw member configured to rotate by a driving device, a guide member extending forwardly and backwardly so as to surround the screw member, a nut member configured to be screwed with the screw member, a slider unit configured to move along the guide member by the nut member, and a rod connected between the slider unit and a door. In addition, the slider unit includes a slider main body and sliding members attached to interpose the slider main body between them.

In the slider driving unit disclosed in Patent Literature 1, a rotation of the screw member allows the movement of the nut member along the screw member, i.e. the guide member. By the movement of the slider unit along the guide member, the rod performs an opening/closing operation of the door. In addition, when the slide unit moves along the guide member, the sliding body slides on (the inner surface of) the guide member.

With such slider driving device (opening/closing operation device) provided in the vehicle, the opening/closing of the door that swings up and down can be performed easily and securely.

### CITATION LIST

### Patent Literature

Patent Literature 1: JP 2009-155900 A

### SUMMARY OF INVENTION

### Technical Problem

However, when opening/closing the opening/closing body with the slider driving device of Patent Literature 1, since the opening/closing body has to be operated while resisting its weight, a large amount of load is applied to the slider. In addition, in the slider having the configuration disclosed in Patent Literature 1, since the load is supported at the side of the slider main body or the sliding members, the slider main body or the sliding members has a risk of damage.

As such, in the present invention, the object is to provide an opening/closing body operation device that ensures the support of the load applied to the slider when the opening/closing body is in opening/closing operation.

### Solution To Problem

To achieve the object described above, the present invention provides an opening/closing body operation device for opening/closing an opening/closing body configured to swing up and down. The opening/losing body operation device includes a driving unit, a slider configured to move upward and downward by a driving power of the driving unit, the slider being connected to the opening/closing body, and a guide member in which the slider is arranged such that the slider can slide. The slider includes a slider main body, a sliding member configured to slide on the guide member, and an elastic member arranged between the slider main body and the sliding member so as to support a load applied to the slider when opening/closing the opening/closing body. A deformation allowable space is defined in the slider. The deformation allowable space is configured to allow elastic deformation of the elastic member caused when the slider is pressed into the guide member.

### Advantageous Effect of Invention

According to the present invention, since the deformation allowable space is defined in the slider, elastic deformation of the elastic member is allowed, thus ensuring the support of the load applied to the slider.

### BRIEF DESCRIPTION OF DRAWING

FIG. 1 is a view illustrating an opening/closing body operation device according to the present invention.

FIG. 2 is a view illustrating the use of an opening/closing body operation device in a vehicle.

FIG. 3 is an exploded perspective view of a slider used in the opening/closing body operation device illustrated in FIG. 1.

FIG. 4A is a front view of the slider main body used in the slider illustrated in FIG. 3.

FIG. 4B is a plan view of the slider main body illustrated in FIG. 4A.

FIG. 4C is a bottom view of the slider main body illustrated in FIG. 4A.

FIG. 4D is a cross sectional view of the slider main body illustrated in FIG. 4B cut with an IV-IV line.

FIG. 5A is a front view of a first liner used in the slider illustrated in FIG. 3.

FIG. 5B is a plan view of the first liner illustrated in FIG. 5A.

FIG. 5C is a side view of the first liner illustrated in FIG. 5A.

FIG. 6A is a front view of a second liner used in the slider illustrated in FIG. 3.

FIG. 6B is a cross sectional view of the second liner illustrated in FIG. 6A cut with a VI-VI line.

FIG. 6C is a bottom view of the second liner illustrated in FIG. 6A.

FIG. 7 is a cross sectional view of an opening/closing body operation device cut along an axis of a guide member.

### DESCRIPTION OF EMBODIMENT

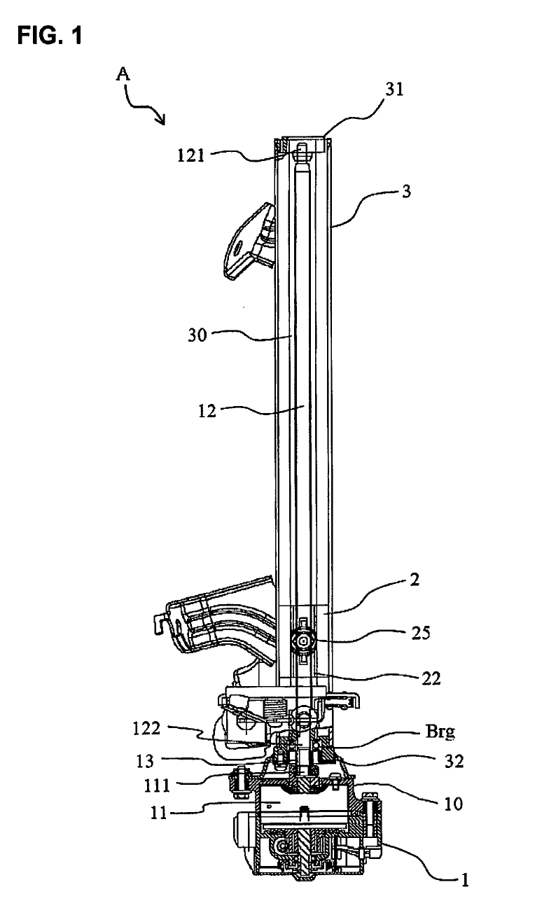

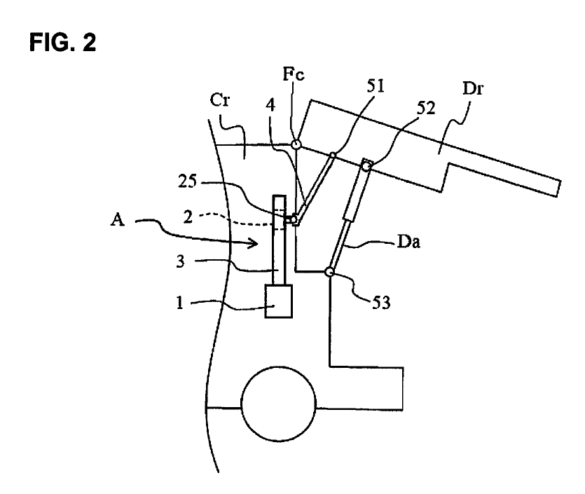

In the following, an embodiment of the present invention will be described with reference to accompanying drawings. FIG. 1 is a view illustrating an opening/closing body operation device according to the present invention and FIG. 2 is a view illustrating the use of an opening/closing body operation device in a vehicle.

First, the embodiment of an opening/closing body operation device according to the present invention is described. As shown in FIG. 2, an opening/closing driving device A is a device that is configured to open/close an opening/closing body Dr arranged inside a vehicle Cr and rotatably connected to a supporting point Fc arranged at the upper end of a back opening part of the vehicle Cr. It should be noted that, in the vehicle Cr, a damper Da (gas damper) configured to assist a movement of the opening/closing driving device A and the opening/closing body Dr is used. It should be noted that an opening/closing operation of the opening/closing body Dr by the opening/closing driving device A will be described later.

As shown in FIG. 1, an opening/closing body operation device A according to the present invention is a device that is configured to perform an opening/closing operation of the opening/closing body Dr that is arranged in a back opening part of the vehicle Cr as shown in FIG. 2 and swings up and down. The opening/closing body operation device includes a driving unit 1, a slider 2 configured to move upward and downward by a driving power of the driving unit 1 and connected to the opening/closing body Dr, and a guide member 3 in which the slider 2 is arranged such that the slider 2 can slide

The driving unit includes a motor not shown in the figure, a clutch 11 that is connected to an output shaft of the motor, and a male threaded shaft 12 that is connected to the motor via the clutch 11, rotated by the driving power of the motor, and inserted to the guide member 3. It should be noted that the driving unit 1 includes, other than the above, a reducer and a coupling 13 connecting the output shaft of the clutch 11 with the male threaded shaft 12.

The guide member 3 is a member that guides the movement of the slider 2 and supports the male threaded shaft 12. The guide member 3 is a metal plate having a substantially C-shaped cross section and an opening 30 continuing in a longitudinal direction is formed. In addition, a set plate 31 is attached at the longitudinal tip of the guide member 3 and a bracket 32 is fixed at the longitudinal base.

In the inner space of the guide member 3, the male threaded shaft 12 is arranged such that the male threaded shaft 12 does not make contact with the guide member 3 and is substantially parallel to the opening 30. Male threads are not formed at the tip of the male threaded shaft, i.e. the male threaded shaft 12 has a round-bar-shaped tip portion 121 and is rotatably supported by the set plate 31. The part of the base side of the male threaded shaft 12 also has a round-bar-shaped base portion 122 where male threads are not formed. The base portion 122 is rotatably supported by the bracket 32 via a bearing Brg.

Since the tip portion 121 is supported by the set plate 31, the base portion 122 is supported by the bracket 32 via the bearing Brg, and the base portion 122 is connected with the output shaft 111 of the clutch 11 via the coupling 13 such that the axis of the base portion 122 corresponds to that of the output shaft 111, the male threaded shaft 12 is supported such that the rotation axis does not swing during the rotation. It should be noted that the method of supporting the male threaded shaft 12 is not limited to this, and any methods in which the rotation axis does not swing during the rotation can broadly be used. The connection between the base portion 122 and the coupling 13 is achieved by screwing together the male threads formed at the base side tip of the base portion 122 and female threads formed on the inner circumferential surface of the coupling 13 and swaging them from the radial outer direction of the coupling 13 towards the radial inner direction. It should be noted that the method for connecting the base portion 122 and the coupling 13 is not limited to this, and any connection methods in which the rotation axis does not swing during the rotation of the male threaded shaft 12 can broadly be used. Thus, the driving power of the motor is transmitted to the male threaded shaft 12 via the clutch 11 (output shaft 111) and the coupling 13 and the male threaded shaft 12 rotates.

In addition, the bracket 32 is attached to a housing 10 of the driving unit 1.

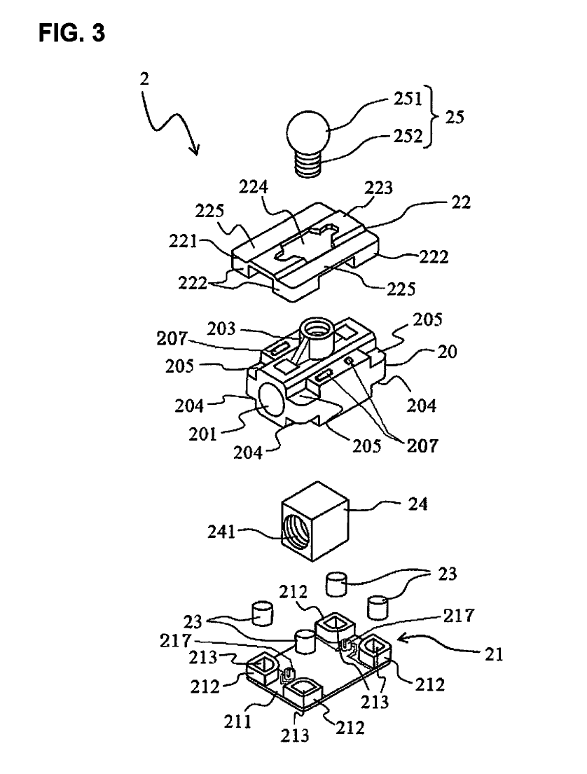

The details of the slider 2 will be described with reference to accompanying drawings. FIG. 3 is an exploded perspective view of a slider used in the opening/closing body operation device illustrated in FIG. 1. The slider 2 is slidably arranged inside the guide member 3.

As shown in FIG. 3, the slider 2 includes a slider main body 20, a first liner 21 that is arranged to the inner surface of the guide member 3 opposite to the opening 30 and is a sliding member sliding on the guide member 3, a second liner 22 that is arranged between the inner surface of the guide member 3 adjacent to the opening 30 and the slider main body 20, and elastic members 23 that are arranged between the first liner 21 and the slider main body 20 and support a load applied to the slider 2 when opening/closing the opening/closing body Dr.

It should be noted that, in the slider 2, the first liner 21 is the sliding member, however, there is a case where the second liner 22 is also configured to slide on the guide member 3. In this case, the second liner 22 is also the sliding member and the elastic member 23 may be arranged between the second liner 22 and the slider main body 20. In addition, the second liner 22 may be omitted if the friction or wear, due to the contact of the side of the slider main body 20 to which the second liner 22 is attached with the inner surface of the guide member 3, is small and can be ignored.

As shown in FIG. 3, the elastic members 23 are formed in a shape of column with a circular cross section and, so as to support the load applied to the slider when opening/closing the opening/closing body Dr, the elastic members 23 are made of resilient materials such as chloroprene rubber and etc. and arranged between the slider main body 20 and the first liner 21 which is the sliding member. Any configurations of the elastic members can be used, provided that the elastic members can support the load applied to the slider 2.

The slider 2 further includes a nut 24 that is attached to the slider main body 20 and has a female threaded portion 241 screwed with the male threaded shaft 12, and an arm stud 25 that is also attached to the slider main body 20 and connected to a connection member 4 connecting the opening/closing body Dr with the slider 2.

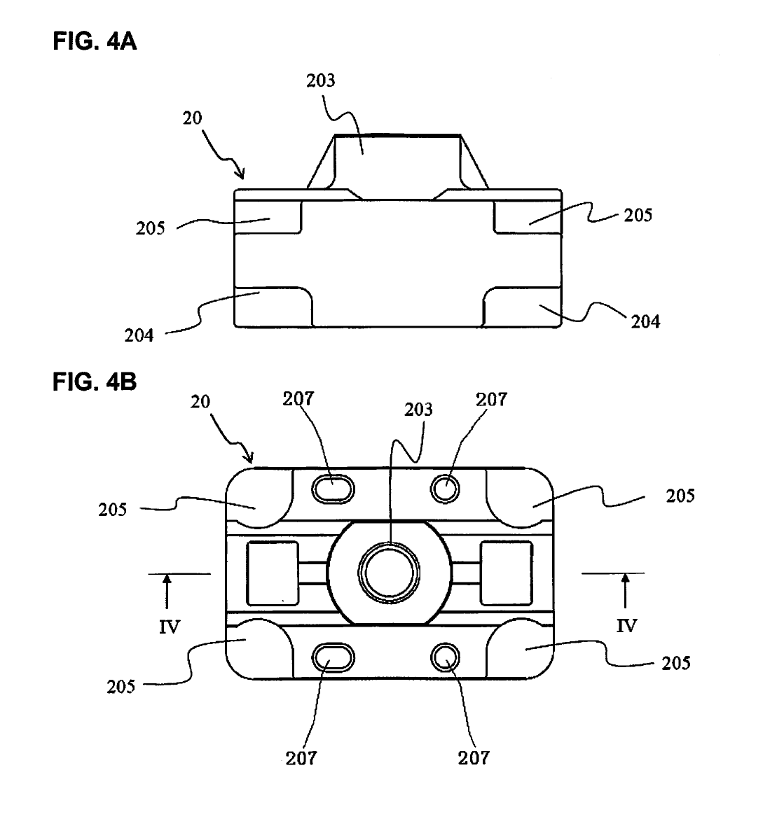

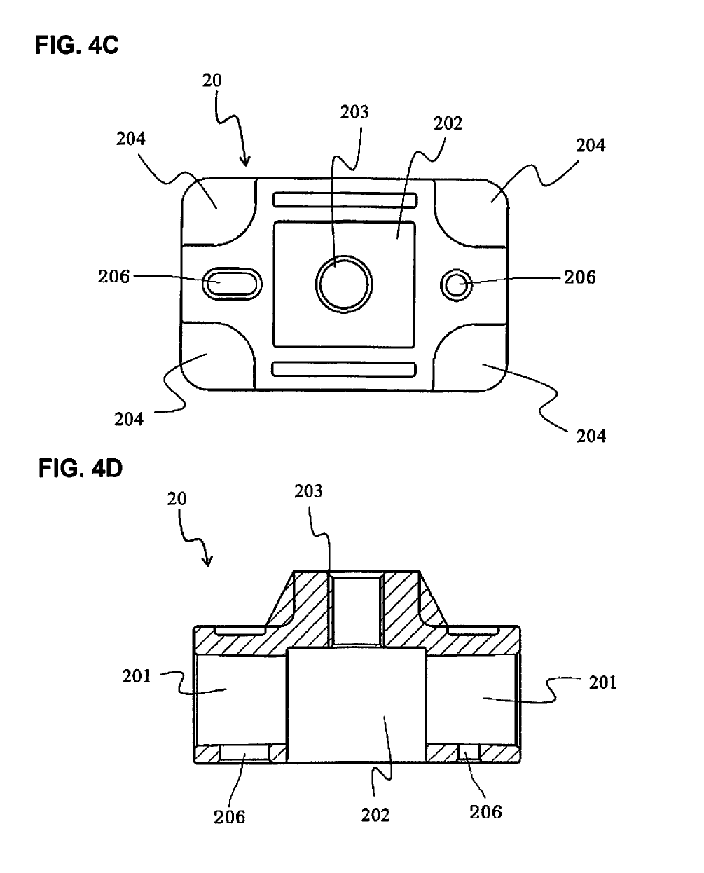

The details of the slider main body 20 will be described. FIG. 4A is a front view of the slider main body 20 used in the slider 2 illustrated in FIG. 3, FIG. 4B is a plan view of the slider main body illustrated in FIG. 4A, FIG. 4C is a bottom view of the slider main body illustrated in FIG. 4A, and FIG. 4D is a cross sectional view of the slider main body illustrated in FIG. 4B cut with an IV-IV line.

The slider main body 20 is formed with an opening portion 201 through which the male threaded shaft 12 passes (See FIG. 4D). The opening portion 201 is a through-hole extending in parallel to the longitudinal direction of the slider main body 20. A concave hole 202 having a rectangular parallelepiped shape is formed at the central part of the longitudinal direction of the slider main body 20, and the concave hole 202 communicates with the opening portion 201 (See FIG. 4C and FIG. 4D). The nut 24 (See FIG. 3), which has the female threaded portion 241 screwed with the male threaded shaft 12 and has a rectangular parallelepiped in its external shape, is inserted into the concave hole 202. Since the external shape of the nut 24 is a quadrangle and the shape of the concave hole 202 is the quadrangle slightly larger than the external shape of the nut 24, and since the nut 24 makes contact with the inner surface of the concave hole 202 even if the nut 24 intends to rotate when the nut 24 is inserted into the concave hole 202, the rotation of the nut 24 is inhibited.

As shown in FIG. 4A and FIG. 4D, a stud fixing portion 203 having a cylindrical shape where the arm stud 25 is fixed is formed on the upper surface of the slider main body 20 and its inner portion goes through to the concave hole 202. Female threads are formed on the inner surface of the stud fixing portion 203 and can be screwed with male threads of a leg portion 252 of the arm stud 25.

As shown in FIG. 3, FIG. 4A, FIG. 4B, and FIG. 4C, notches 204 and notches 205 are formed at four edges of the lower surface and upper surface of the slider main body 20, respectively. A protrusion portion 212 of the first liner 21 and a protrusion portion 222 of the second liner 22 engage with the notches 204 at the lower surface and the notches 205 at the upper surface, respectively.

It should be noted that the slider main body 20 is made of metal materials such as zinc alloys, aluminum alloys, and etc. and produced by die casting. In addition, the materials and production method are not limited to these, and any materials and production methods, which can inhibit the damage caused by the application of load due to the weight of the opening/closing body and form it in light weight, can broadly be used. Moreover, the nut 24 is made of cupper alloys, but not limited to this.

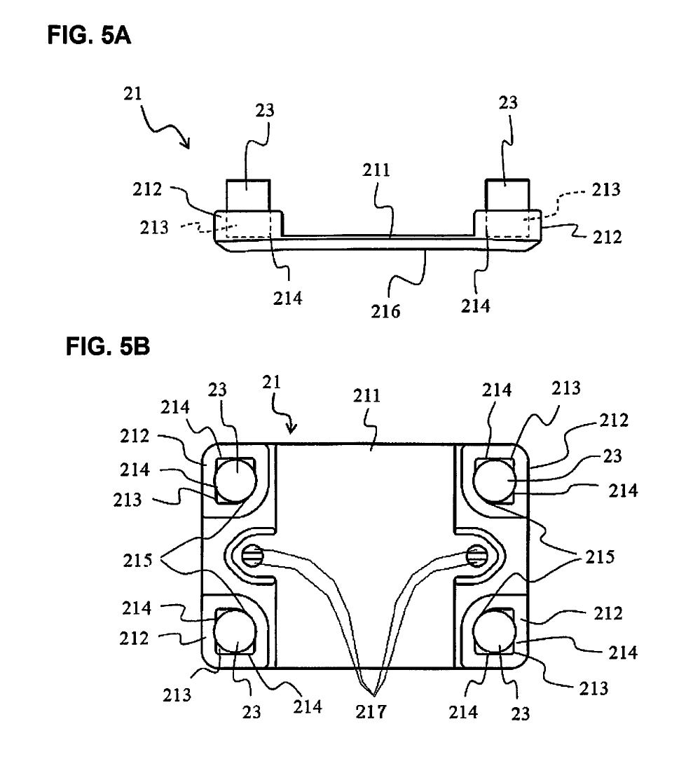

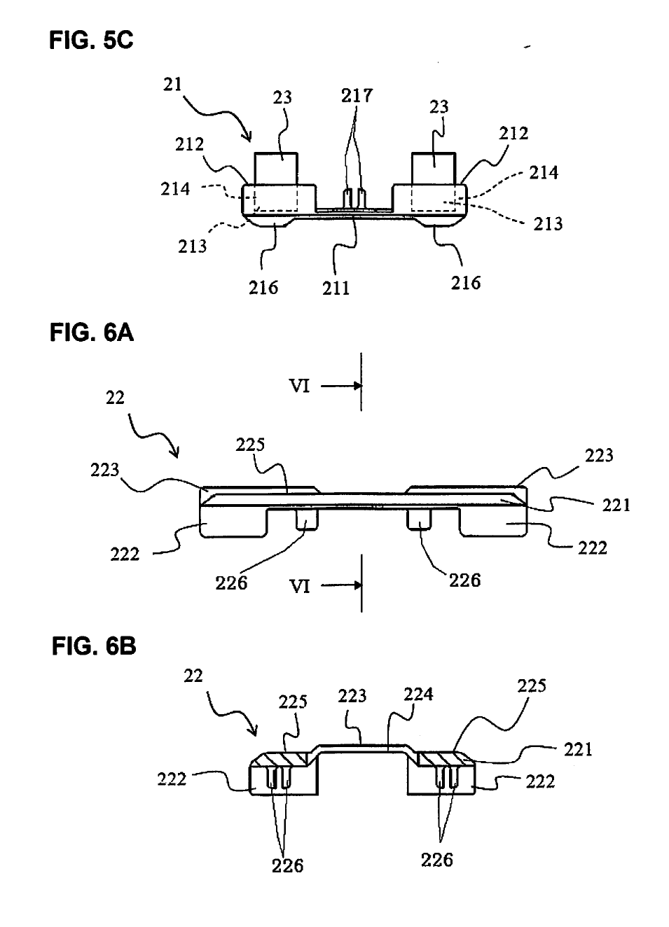

Next, the first liner 21, which is arranged to the lower surface of the slider main body 20 and is a sliding body, will be described with reference to new drawings. FIG. 5A is a front view of the first liner 21 used in the slider 2 illustrated in FIG. 3, FIG. 5B is a plan view of the first liner 21 illustrated in FIG. 5A, and FIG. 5C is a side view of the first liner 21 illustrated in FIG. 5A. It should be noted that FIG. 5A-FIG. 5C illustrate the first liner 21 in which the elastic members 23 are attached.

The first liner 21 is a member that is arranged between the slider main body 20 and the surface of the inner surface of the guide member 3 opposite to the opening 30 and allows the smooth sliding of the slider 2. The first liner 21 includes a body portion 211 having a rectangular shape in planar view, protrusion portions 212 that protrude from four edges and engage with the notches 204 of the slider main body 20, and engaging concave portions 213. As a misalignment prevention potions, the engaging concave portions 213 open towards the upper surface (the surface opposite to the slider main body 20), through which the elastic members 23 are inserted (with pressure) into the inside of the protrusion portions 212 in order to prevent the misalignment of the elastic members 23.

As shown in FIG. 5B, the protrusion portion 212 and the engaging concave portion 213 have substantially the same shape. The protrusion portion 212 is formed with the shape in which the notch 204 can insert the protrusion portion 212. In addition, the engaging concave portion 213 is formed in fan-shaped at one corner and has a round-cornered rectangular shape at the rest of the corners. The engaging concave portion 213 is formed with two surface portions 214 and a round surface portion 215 in which the corner arranged diagonally opposite to the corner at which the surface portions 214 cross has a circular arc shape.

The length of the surface portion 214 of the engaging concave portion 213 is smaller than the diameter of the part of the elastic member 23 which is inserted into the engaging concave portions 213. Thus, the elastic member 23 can be held at three points that are the two surface portions 214 and the round surface portion 215, so that the elastic member 23 hardly comes out from the engaging concave portion 213, and the drop out (misalignment) of the elastic member 23 can be inhibited. In addition, since the elastic member 23 is held at three points, the drop out of the elastic member 23 can be inhibited even if the elastic member 23 is compressed and deformed elastically. The engaging concave portion 213 that is the misalignment preventing portion can be any shapes other than concave, provided that the engaging concave portion 213 can prevent the misalignment of the elastic member.

The depth of the engaging concave portion 213, i.e. the protrusion height of the protrusion portion 212 is shorter than the axial length of the elastic member 23. Thus, the tip of the part of the elastic member 23 protruding from the engaging concave portion 213 makes contact with the bottom surface of the notch 204, i.e. the slider main body 20, when the first liner 21 is attached to the slider main body 20.

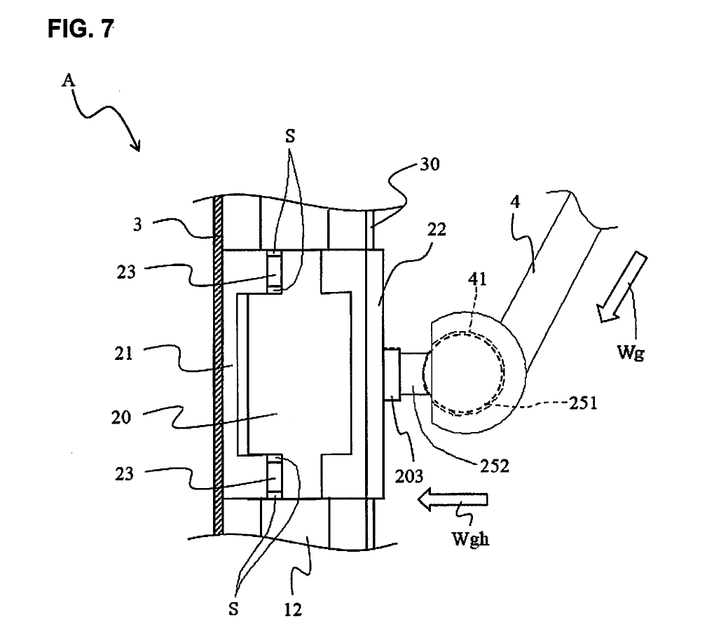

With such configuration, when the slider 2 is pressed into the guide member 3 by compressing the elastic members 23, a gap is formed at the part between the engaging concave portions 213 and the notches 204. This gap acts as a deformation allowable space S that allows elastic deformation of the elastic members 23 caused when the elastic members 23 are compressed due to the load of the opening/closing body Dr applied to the slider 2 when opening/closing the opening/closing body Dr (See FIG. 7). In other words, one end of the elastic member 23 is arranged in the engaging concave portion 213 that is the misalignment prevention portion, and another end of the elastic member 23 protruding from the engaging concave member that is the misalignment prevention portion is arranged in the deformation allowable space S. Since the deformation due to the compression of the elastic members 23 can absorb the load, the deformed parts can escape to the deformation allowable space, and the area supporting the slider main body 20 and the first liner 21 increases, the support of the load applied to the slider 2 is ensured.

For the above reason, even if the elastic members 23 are elastically deformed (compressed), the formation of the deformation allowable space S in the slider 2 allows their deformation.

It should be noted that there is still a gap between the elastic members 23 and the engaging concave portions 213 even after the elastic members 23 are pressed into the engaging concave portions 213. When the elastic members 23 is compressed in the axial direction, the elastic members 23 deform and extend into the gaps in the engaging concave portions 213. The existence of the gap in the engaging concave portions 213 allows the elastically deformed part of the elastic members 23 to extend into the gaps in the engaging concave portions 213. The gap in the engaging concave portions 213 can also act as the deformation allowable space that allows the elastic deformation caused when the elastic member 23 is compressed.

Since the gap between the engaging concave portions 213 and the notches 204 acts as the deformation allowable space of the elastic members 23, the support of the load applied to the slider 2 is ensured.

Two sliding portions 216 having a convex shape extending in the longitudinal direction are formed in the lower surface of the first liner 21 (the surface opposite to the side on which the protrusion portions 212 are formed). The formation of the sliding portion 216 reduces the surface contacting the guide member 3, thus reducing the friction heat as the contacting surface reduces.

It should be noted that the upper surface of the first liner 21 of the body portion 211 has two engaging portions 217 formed in shape of the rods (in shape of split pins) engaging with two concave portions 206 formed in the slider main body 20. The engagement of the concave portions 206 and the engaging portions 217 allows the first liner 21 to be positioned with respect to the lower surface of the slider main body 20, and inhibits the first liner 21 from being misaligned with respect to the slider main body 20 and from dropping out.

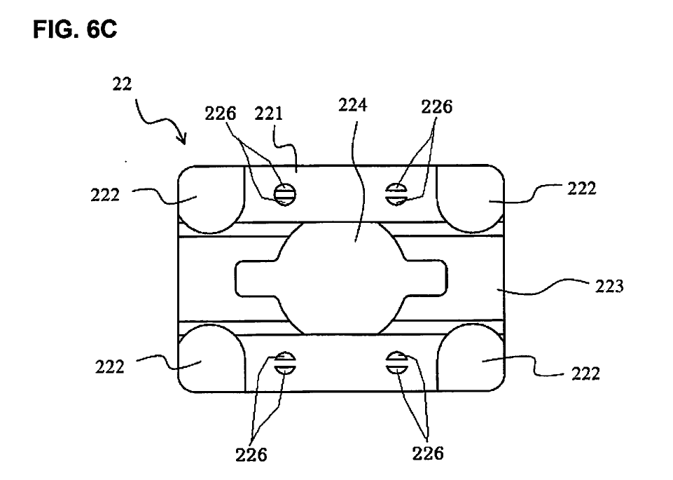

Next, the second liner 22 will be described with reference to new drawings. FIG. 6A is a front view of the second liner 22 used in the slider 2 illustrated in FIG. 3, FIG. 6B is a cross sectional view of the second liner 22 illustrated in FIG. 6A cut with a VI-VI line, and FIG. 6C is a bottom view of the second liner 22 illustrated in FIG. 6A.

As shown in FIG. 6C, the second liner includes a body portion 221 and protrusion portions 222 protruding downwardly from four edges of the lower surface side of the body portion 221. The body portion 221 extends in the longitudinal direction between the protrusion portions 222, and has convex portions 223 to be arranged in the opening 30 of the guide member 3, and the central part of the body portion 221 has a through-hole 224 through which the stud fixing portion 203 passes when the second liner 22 is attached to the upper surface of the slider main body 20. The upper surface of the body portion 221 of the second liner 22 has a sliding portion 225 sliding on the inner surface of the guide member 3 adjacent to the opening 30.

The protrusion portions 222 have the shape that can engage with the notches 205 formed at four edges of the upper surface of the slider main body.

The lower surface of the body portion 221 of the second liner 22 has engaging portions 226 formed in shape of the rods (in shape of split pins) engaging with concave portions 207 formed in the slider main body 20. The engagement of the concave portions 207 and the engaging portions 226 allows the second liner 22 to be positioned with respect to the upper surface of the slider main body 20, and inhibits the second liner 22 from being misaligned with respect to the slider main body 20 and from dropping out. With the positioning of the second liner 22 with respect to the upper surface of the slider main body 20, the stud fixing portion 203 passes through the through-hole 224.

As shown in FIG. 3, a head portion 251 of the arm stud 25 is formed in spherical shape and a leg portion 252 is formed in cylindrical shape with male threads. The arm stud 25 is a connector that relative-rotatably connects the connection member 4 with the slider 2.

Next, the method of attaching the slider 2 to the guide member 3 will be described with reference to drawings. As shown in FIG. 3, the elastic members 23 are attached to each of four engaging concave portions 213 of the first liner 21. Here, since the elastic members 23 are held by two surface portions 214 and the round surface portion 215, the elastic members 23 hardly drop out.

The first liner 21 is attached to the lower surface of the slider main body 20 such that the protrusion portions 212 are arranged in the notches 204, the end portions of the elastic members 23 engage with the bottom surfaces of the notches 203, and the engaging portions 217 of the first liner 21 engage with the concave portions 206 formed in the lower surface of the slider main body 20. In addition, when the first liner 21 is attached, the nut 24 is inserted into the concave hole 202 of the slider main body 20. The nut 24 is inserted into the concave hole 202 such that the central axis of the female threads 241 coincides with the central axis of the opening portion 201.

Similarly to the attachment of the first liner 21, the second liner 22 is attached to the upper surface of the slider main body 20 such that the protrusion portions 222 are arranged in the notches 205 and the engaging portions 226 engage with the concave portions 207 formed in the upper surface of the slider main body 20. Here, the stud fixing portion 203 formed on the upper surface of the slider main body 20 passes through the through-hole 224.

The slider main body 20 is sandwiched from top and bottom between the first liner 21 and the second liner 22. Here, the thickness of the slider 2 in the axial direction of the arm stud 25 is larger than the height from the inner surface of the guide member 3 adjacent to the opening 30 to the inner surface of the guide member 3 opposite to the opening 30. For this, by pushing the first liner 21 to the slider main body 20 to compress (elastically deform) the elastic members 23, the thickness of the slider 2 is compressed to the thickness smaller than the height from the inner surface of the guide member 3 adjacent to the opening 30 to the inner surface of the guide member 3 opposite to the opening 30. The compressed slider 2 is inserted into inside of the guide member 3 from the end portion of the guide member 3 such that the stud fixing portion 203 protrudes from the opening 30 of the guide member 3 to outside. The slider 2 is inserted into inside of the guide member 3 such that the longitudinal direction of the slider 2 coincides with the longitudinal direction of the guide member 3.

Here, due to the resilience of the elastic members 23, the sliding portion 216 is pushed to the surface of the guide member 3 opposite to the opening portion 30 and the sliding portion 225 of the second liner 22 is pushed to the inner surface of the guide member 3 adjacent to the opening portion 30. Thus, the slider 2 is arranged inside the guide member 3 while inhibiting the rattling.

The driving unit 1 is attached to the guide member 3 and the male threaded shaft 12 is arranged inside the guide member 3. The male threaded shaft 12 passes through the opening portion 201 and the male threaded shaft 12 is screwed with the female threads 241 of the nut 24. With this configuration, the slider 2 is attached inside the guide member 3, the set plate 31 is attached to the tip portion of the guide member 3, and the tip portion 121 of the male threaded shaft 12 is rotatably held by the set plate 31.

By performing the process described above, the assembling process of the opening/closing body operation device A completes. In the opening/closing body operation device A, the slider is arranged inside the guide member 3, the male threaded shaft 12 passes through the opening portion 201 of the slider 2 without contact, and the female threads 241 of the nut 24 is screwed with the male threaded shaft 12. In this configuration, if the driving power generated by the driving of the motor is transmitted from the output shaft 111 of the driving unit 1, via the coupling 13, to the male threaded shaft 12, the male threaded shaft 12 rotates.

By the rotation of the male threaded shaft 12, the nut 24 in which the female threads 241 are formed, i.e. the slider 2, moves. As described above, since the rotation of the nut 24 is restricted inside the concave hole 202 of the slider main body 20, the nut 24 does not rotate and a force acts in the axial direction of the male threaded shaft 12. Thus, the male threaded shaft 12 is rotated by the driving force of the motor, and by the rotation of the male threaded shaft 12, the slider 2 moves in the axial direction of the male threaded shaft, i.e. the longitudinal direction of the guide member 3.

Next, the operation of the opening/closing body operation device A will be described with reference to drawings. FIG. 7 is a cross sectional view of the opening/closing body operation device A cut along the axis of the guide member 3. As shown in FIG. 2, the opening/closing body operation device A is attached to the vehicle Cr such that the longitudinal direction of the guide member 3 corresponds to the vertical direction. In addition, as shown in FIG. 2 and FIG. 7, the guide member 3 is attached to the vehicle Cr such that the opening 30 faces the opening/closing body Dr.

The damper Da (gas damper), that helps the opening/closing operation of the opening/closing body Dr, i.e. biases the opening/closing body Dr upwardly, is attached to the vehicle Cr. Since the angle of the damper Da varies in accordance with the opening/closing of the opening/closing body Dr, a hinge 53 connects the damper Da with the opening/closing body Dr and a hinge 53 connects the damper Da with the vehicle Cr (See FIG. 2).

As described above, the slider 2 of the opening/closing body operation device A moves along the longitudinal direction of the guide member 3. The slider 2 is connected with the opening/closing body Dr by the connection member 4, the opening/closing body Dr performs its opening operation when the slider 2 moves upward, and the opening/closing body Dr performs its closing operation when the slider 2 moves downward.

As shown in FIG. 1 and FIG. 7, the connection member 4 is swingably connected with the head portion 251 of the arm stud 25 at the concave portion 41 with substantially spherical shape arranged at one end of the connection member 4. Another end of the connection member 4 is rotatably connected with the opening/closing body Dr via the hinge 51.

When the slider 2 moves along the guide member 3, the angle of the connection member 4 with respect to the guide member 3 varies. In this case, as the inner circumferential portion of the concave portion 41 of the connection member 4 makes contact with the spherical head portion 251 of the arm stud 25, the angle of the connection member 4 can smoothly vary. It should be noted that the connection of the connection member 4 with the slider unit 2 is not limited to this, the connection methods in which the connection member 4 can swing with respect to the slider 2 and transmit a force can broadly be used.

Next, the force acting from the connection member 4 to the slider 2 will be described. During the opening/closing operation of the opening/closing body Dr, the weight of the opening/closing body Dr is supported by the connection member 4 and the damper Da. Therefore, the load Wg due to the weight of the opening/closing body Dr acts on the slider 2 via the connection member 4 (See FIG. 7). The load Wg is transmitted from the concave portion 41 of the connection member 4 to the stud fixing portion 203. Since the connection member 4 is connected with angle with respect to the slider 2, the load Wg acting on the slider 2 via the connection member 4 is divided into the component in the moving direction of slider 2 and the component in the direction perpendicular to the moving direction.

Since the male threaded shaft 12 is screwed with the female threads 241 of the nut 24 in the slider 2, the component of the load Wg in the moving direction of the slider 2 is supported by the male threaded shaft 12. Therefore, of the load Wg acting on the slider 2 via the connection member 4, the load Wgh in the direction perpendicular to the moving direction of the slider 2 will be described.

Since, in the opening/closing body operation device A, the guide member 3 is attached to the vehicle Cr such that the opening 30 faces the opening/closing body Dr, the load Wgh in the direction perpendicular to the moving direction of the slider 2 acts in the direction pushing the first liner 21 of the slider unit 2 to the inner surface of the guide member 3.

In the slider 2, the elastic members 23 that are elastic deformation bodies are arranged between the slider main body 20 and the first liner 21 and the elastic members 23 are compressed by acting the load Wgh. The action of the load compressing the elastic members 23 elastically deforms the elastic members 23.

The deformed portions of the elastic members 23 extends into the gaps of the engaging concave portions 213 of the first liner 21. This deformation of the elastic members 23 reduces the load applied to the first liner by the load Wgh. Thus, the deformation, damage, and etc. of the first liner 21 can be inhibited. The reduction of the load applied to the first liner can inhibit the increase of the contact pressure acting between the sliding portion 216 of the first liner 21 and the inner surface of the guide member 3. This can also inhibit the deformation, damage, wear, and etc. of the first liner 21.

Thus, the load of the opening/closing body Dr can firmly be received without increasing the side of the opening/closing body operation device A, even if the opening/closing body Dr is heavy. Consequently, the stable opening/closing of the opening/closing body can be performed for long periods of time.

In the above-described slider 2, the cylindrical elastic members 23 are attached between the slider main body 20 and the first liner 21, however not limited to this, elastic members having shapes, other than cylinder, which are columns longer in their axial direction (e.g. quadratic prism, triangular prism, etc.) may be used. In addition, the number of the elastic members 23 is not limited to four.

Moreover, in the slider 2, the elastic members 23 are arranged between the slider main body 20 and the first liner 21, however not limited to this, the elastic member(s) 23 may also be attached between the slider main body 20 and the second liner 22.

In the above, the embodiments of the present invention are described, however, the present invention is not limited to this context. In addition, any modifications and/or changes can be made to the embodiments of the present invention without departing from the spirit of the invention.

### INDUSTRIAL APPLICABILITY

This invention can be used as opening/closing body operation devices that perform opening/closing operations of opening/closing bodies that swing up and down, such as hatch gates of cars, trunk lids, and the like.

### REFERENCE SIGN LIST

A OPENING/CLOSING BODY OPERATION DEVICE
1 DRIVING UNIT
10 HOUSING
11 CLUTCH
111 OUTPUT SHAFT
12 MALE THREADED SHAFT
121 TIP PORTION
122 BASE PORTION
13 COUPLING
2 SLIDER
20 SLIDER MAIN BODY
201 OPENING PORTION
202 CONCAVE HOLE
203 STUD FIXING PORTION
204 NOTCH
205 NOTCH
21 FIRST LINER (SWINGING MEMBER)
211 BODY PORTION
212 PROTRUSION PORTION
213 ENGAGING CONCAVE PORTION
214 SURFACE PORTION
215 ROUND SURFACE PORTION
216 SLIDING PORTION
22 SECOND LINER
221 BODY PORTION
222 PROTRUSION PORTION
223 CONVEX PORTION
224 THROUGH-HOLE
225 SLIDING PORTION
23 ELASTIC MEMBER
24 NUT
241 FEMALE THREAD
25 ARM STUD
251 HEAD PORTION
252 LEG PORTION
3 GUIDE MEMBER
30 OPENING
31 SET PLATE
32 BRACKET
4 CONNECTION MEMBER
41 CONCAVE PORTION
51, 52, 53 HINGE
Cr VEHICLE
Dr OPENING/CLOSING BODY
Da DAMPER (GAS DAMPER)

1. An opening/closing body operation device for opening/closing an opening/closing body configured to swing up and down, the opening/closing body operation device comprising:
a driving unit;
a slider configured to move upward and downward by a driving power of the driving unit, the slider being connected to the opening/closing body; and
a guide member in which the slider is arranged such that the slider can slide,
the slider including:
a slider main body;
a sliding member configured to slide on the guide member; and
an elastic member arranged between the slider main body and the sliding member so as to support a load applied to the slider when opening/closing the opening/closing body, such that a deformation allowable space is defined in the slider, the deformation allowable space being configured to allow elastic deformation of the elastic member caused when the slider is pressed into the guide member.

2. The opening/closing body operation device according to claim 1, wherein
the driving unit has a motor, a male threaded shaft inserted in the guide member and configured to be rotated by a driving power of the motor;
the slider has a female threaded portion configured to be screwed with the male threaded shaft and is configured to move by a rotation of the male threaded shaft; and
the male threaded shaft is supported such that a rotation axis does not swing during the rotation.

3. The opening/closing body operation device according to claim 1, further comprising
a misalignment prevention portion arranged in the slide member, the misalignment prevention portion being configured to prevent a misalignment of the elastic member; and
wherein
the elastic member is formed in a shape of column, one end of the elastic member is arranged in the misalignment prevention portion and another end of the elastic member protruding from the misalignment prevention portion is arranged in the deformation allowable space.
